(19) United States
(12) Patent Application Publication
(10) Pub. No.: US 2021/0274744 A1
(43) Pub. Date: Sep. 9, 2021

(54) METHODS AND COMPOSITION FOR SUPPRESSION OF AMMONIA FORMATION

(71) Applicants: Dow Global Technologies LLC, Midland, MI (US); Rohm and Haas Company, Philadelphia, PA (US)

(72) Inventors: Ashwin R. Bharadwaj, Pearland, TX (US); Sara B. Klamo, Chicago, IL (US); Aslin Izmitli, Yardley, PA (US); Bruce D. Hook, Lake Jackson, TX (US); Kimberly A. Surber, Lake Jackson, TX (US); Stephen E. Fosdick, Pearland, TX (US); Sung-Yu Ku, Pearland, TX (US)

(21) Appl. No.: 16/495,137

(22) PCT Filed: Mar. 21, 2018
(86) PCT No.: PCT/US2018/023450

§ 371 Date: Sep. 18, 2019

Related U.S. Application Data
(60) Provisional application No. 62/474,662, filed on Mar. 22, 2017.

(51) Int. Cl. A01K 1/015

(52) U.S. Cl. CPC A01K 1/0155; A01K 1/0154

(57) ABSTRACT

A method for suppressing the formation of ammonia comprising providing a carrier material to a container having a headspace; providing a bacteria and an odor inhibitor to the carrier material, the bacteria comprising Staphylococcus-xylosus and/or Staphylococcus-cohnii bacteria, and the odor inhibitor comprising an aminopolycarboxylic acid compound and a polyprotic acid compound, wherein at least one of the aminopolycarboxylic acid compound or the polyprotic acid compound is the salt form of the acid; and applying animal waste to the carrier material; wherein there is a 5 to 98 percent improvement of ammonia content in the headspace as compared to an untreated control comprising a container containing the carrier material and the bacteria and not contain the odor inhibitor. An ammonia suppressing composition.

### BACKGROUND

Animal litter is used as a catch material for biological by-products such as feces and urine. These biological by-products can develop strong odors due to evolution of malodorous compounds such as ammonia. Ammonia results from microbial action on urea and/or uric acid in the biological by-products.

The odor from animal litters is distressing to humans and at sufficiently high levels, may be toxic. In addition, the odor is distressing to the welfare of the animals, especially in closed environments such as poultry houses and horse stalls/barns. Moreover, emissions from animal litter may contribute to the greenhouse effect. It is desirable, therefore, to find ways of controlling odors from animal litter.

The problem addressed by this invention is a method and composition for suppressing ammonia formation to reduce odors from biological by-products.

### STATEMENT OF INVENTION

A method for suppressing the formation of ammonia comprising: providing a carrier material to a container having a headspace; providing a bacteria and an odor inhibitor to the carrier material, the bacteria comprising Staphylococcus-xylosus and/or Staphylococcus-cohnii bacteria, and the odor inhibitor comprising an aminopolycarboxylic acid compound and a polyprotic acid compound, wherein at least one of the aminopolycarboxylic acid compound or the polyprotic acid compound is the salt form of the acid; and applying animal waste to the carrier material; wherein there is a 5 to 98 percent improvement of ammonia content in the headspace as compared to an untreated control comprising a container containing the carrier material and the bacteria and not contain the odor inhibitor.

An odor control system comprising: a carrier material and an odor inhibitor, the odor inhibitor comprising an aminopolycarboxylic acid compound and a polyprotic acid compound, wherein at least one of the aminopolycarboxylic acid compound or the polyprotic acid compound is the salt form of the acid.

### DETAILED DESCRIPTION

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

The terms “prevent” or “suppress” as used herein means at least partly reducing the amount of ammonia that would otherwise be formed in animal waste in the absence of the odor inhibitor and is reported as a “percent improvement”. In some embodiments, the percent improvement is at least 50 percent, alternatively at least 70 percent, alternatively at least 90 percent, or alternatively 100 percent, as measured for instance by colorimetric indicators (e.g., using Drager tubes described in the Examples), optical transmission absorption methods and/or gas chromatography in real time animal usage or laboratory testing method that mimics urine degradation. The percent improvement is relative a system containing the same carrier material and bacteria as the test environment but omitting the odor inhibitor.

The term “animal” as used in this specification generally means non-human animals. Non-limiting examples include domesticated animals, zoo animals, farm animals, pets, and other animals that spend some of their time in a partially or fully enclosed environment. More specific examples include, without limitation, cats, dogs, poultry (e.g., chickens), horses, cows, swine, rabbits, goats, and rodents (e.g., guinea pigs, hamsters, ferrets, mice, and rats).

The term “waste” refers to any animal waste product that may be evolve ammonia in the presence of bacteria. In one instance, waste refers to any animal waste product that contains urea, uric acid, or both. Examples include animal urine and excrement (feces, droppings).

The term “neutralization” refers to an acid that has been at least partially deprotonated. It is understood that the acid could be deprotonated prior to application to the carrier material. It is also understood that certain carrier materials may neutralize the acids.

The present disclosure describes a method and composition for suppressing ammonia formation. The method of the present disclosure includes providing a carrier material, a bacteria and an odor inhibitor to a container having a headspace. Without being limited by theory, it is anticipated that the ammonia is formed by bacteria interaction with a urea derivative, for example urea or uric acid. The bacteria used in the method of the present disclosure are bacteria of the species Staphylococcus-xylosus and Staphylococcus-cohnii. When it is stated that the bacteria are of an identified species, it is understood that bacteria naturally evolve and mutate, and as such, a bacteria is understood to be of the same species when it shares at least 97 percent of the genetic makeup with the target species.

The headspace is defined as the unfilled space above the carrier material in the container. The container is defined as any structure which is suitable for holding the carrier material. In one instance the container is a litter box. In one instance, the container is a surface such as the floor of an animal stall or a room. In one instance the container is at least partially enclosed. In one instance the container is open to the surrounding area. Where the container is open to the surrounding area, headspace measurements described herein are performed in close proximity to the carrier material, for example one to twelve inches from the upper surface of the carrier material, preferably one to six inches from the upper surface of the carrier material. The carrier material may be any material that is typically used as a bedding or absorbent for animals and their waste and includes, for instance, swellable clays (e.g., bentonite and montmorillonite), non-swellable clays (e.g., kaolin), wood shavings, hay, wood chips, pelletized saw dust, paper, chopped corn cobs, cellulosic fibers and fluff, woven cellulosic fabric, peanut hulls, wood pulp, wheat grass, or mixtures thereof. In some embodiments, the carrier material is bentonite clay. In another embodiment, the carrier is a pad of porous cover material or containing cellulosic fluff, or is a pad of artificial grass.

In some embodiments, the animal is a cat and the carrier material is bentonite clay. In some embodiments, the animal is a cat and the carrier material is wood chips, wood shavings, diatomaceous earth, zeolites, paper byproducts, pine pellets, ground corn cob or pelletized saw dust.

In some embodiments, the animal is a dog and the carrier material is an absorbent pad. In some embodiments this pad comprises cellulosic fibers and a porous cover material. In some embodiments this pad comprises a water-proof backing. In some embodiments, the animal is a dog and the carrier material is a pad of artificial grass or other material designed for animal defecation. In some embodiments, the animal is a dog and the carrier material is wood chips, wood shavings, diatomaceous earth, zeolites, paper byproducts, pine pellets, ground corn cob or pelletized saw dust.

In some embodiments, the animal is poultry and the carrier material is wood chips, wood shavings, diatomaceous earth, zeolites, bentonite clay, paper byproducts. pine pellets, ground corn cob or pelletized saw dust.

In some embodiments, the animal is a horse and the carrier material is wood chips, wood shavings, straw, sand, diatomaceous earth, zeolites, bentonite clay, paper byproducts, pine pellets, ground corn cob or pelletized saw dust.

In some embodiments, the animal is a swine and the carrier material is wood chips, wood shavings, straw, sand, diatomaceous earth, zeolites, bentonite clay, paper byproducts, pine pellets, ground corn cob or pelletized saw dust.

In some embodiments, the animal is a cow and the carrier material is wood chips, wood shavings, straw, sand, diatomaceous earth, zeolites, bentonite clay, paper byproducts, pine pellets, ground corn cob or pelletized saw dust.

In one instance, the odor inhibitor comprises both an aminopolycarboxylic acid compound and a polyprotic acid compound. In one instance, the odor inhibitor comprises an aminopolycarboxylic acid compound. In one instance, the odor inhibitor comprises a polyprotic acid compound.

Surprisingly, the combination of the polyprotic acid compound and the aminopolycarboxylic acid compound show a synergistic effect to reduce ammonia formation at rates significantly beyond what would be expected based on use of the use of either odor inhibitor alone.

In one instance, at least one of the aminopolycarboxylic acid compound or the polyprotic acid compound is the salt form of the acid. Preferred cations for the salt-forms of the acids include sodium or potassium.

As used herein, the salt form of the acid can be the mono, di or tri form of the acid according to the extent of neutralization of the acid.

In some embodiments, the odor inhibitor has a pH in water from 4 to 9, preferably from 4 to 5.5.

In some embodiments, the aminopolycarboxylic acid compound has an ethylenediamine or diethylenetriamine backbone.

In some embodiments, the aminopolycarboxylic acid compound is an ethylenediaminetetraacetic acid, or the salt thereof, a diethylenetriaminepentaacetic acid or the salt thereof, a N-hydroxyethylethylenediaminetriacetic acid or the salt thereof, or a mixture of two or more thereof.

In some embodiments, the aminopolycarboxylic acid compound is a sodium salt of ethylenediaminetetraacetic acid, a potassium salt of ethylenediaminetetraacetic acid, or a mixture thereof.

In some embodiments, the aminopolycarboxylic acid compound is a sodium salt of ethylenediaminetetraacetic or a mixture of such salts. For instance, the aminopolycarboxylic acid compound is monosodium ethylenediaminetetraacetic acid (NaEDTA), disodium ethylenediaminetetraacetic acid (Na₂EDTA), trisodium ethylenediaminetetraacetic acid (Na₃EDTA), tetrasodium ethylenediaminetetraacetic acid (Na₄EDTA), or a mixture of two or more thereof. In some embodiments, Na₂EDTA is preferred.

In some embodiments, the aminopolycarboxylic acid compound is a potassium salt of ethylenediaminetetraacetic acid or a mixture of such salts. For instance, the odor inhibitor is monopotassium ethylenediaminetetraacetic acid (KEDTA), dipotassium ethylenediaminetetraacetic acid (K₂EDTA), tripotassium ethylenediaminetetraacetic acid (K₃EDTA), tetrapotassium ethylenediaminetetraacetic acid (K₄EDTA), or a mixture of two or more thereof. In some embodiments, K₂EDTA is preferred.

The odor inhibitor comprises an aminopolycarboxylic acid and a polyprotic acid. Preferably, at least one of the aminopolycarboxylic acid and the polyprotic acids are free acids and are not the salt form of the acids. In one instance, the odor inhibitor is prepared by combining the free acid form of an aminopolycarboxylic acid and the salt form of a polyprotic acid. In one instance, the odor inhibitor is prepared by combining the salt form of an aminopolycarboxylic acid and the free acid form of a polyprotic acid. It is understood that equilibrium chemistry will occur between the free acid and the salt form of the acids of the odor inhibitor which may serve to partially neutralize a portion of the free acid. The aminopolycarboxylic acid functions by preventing formation of ammonia, an odor causing compound. In some embodiments, the aminopolycarboxylic acid has an ethylenediamine or diethylenetriamine backbone. In some embodiments, the aminopolycarboxylic acid is ethylenediaminetetraacetic acid, diethylenetriaminepentaacetic acid, N-hydroxyethylethylenediaminetriacetic acid, or a mixture of two or more thereof.

The polyprotic acid compound used herein comprises an acid which neutralizes or suppresses the formation of ammonia and preferably is safe for use with animals. In some embodiments, the polyprotic acid compound is preferably a free acid, meaning an acid that has not been deprotonated. The polyprotic acid is preferably not the salt-form of the acid. A polyprotic acid is an acid which is capable of losing more than one proton per molecule. In one instance, the polyprotic acid compound used herein is citric acid or citrate. In one instance, the polyprotic acid compound is citric acid, citrate, maleic, succinic, malonic, aspartic, the salt form of any of these acids, or a combination thereof. Other polyprotic acid compounds include sulfuric, sulfurous, phosphoric, carbonic, malic, terephthalic, tartaric, oxalic, malonic, phthalic, and aspartic, phthalic, fumaric, oxalic, tartaric, adipic, glutaric, glutaconic, citraconic, malic, glutamic, tartronic, oxaloacetic, aconitic, propane tricarboxylic acid.

It is understood that the polyprotic acid compound will be present in equilibrium, and a portion of the acid will be present in the free acid form. In one instance, at least 1% of the polyprotic acid is present in the free acid form. In one instance, at least 5% of the polyprotic acid is present in the free acid form. In one instance, at least 10% of the polyprotic acid is present in the free acid form. In one instance, at least 15% of the polyprotic acid is present in the free acid form. In one instance, at least 20% of the polyprotic acid is present in the free acid form. In one instance, at least 25% of the polyprotic acid is present in the free acid form. In one instance, at least 50% of the polyprotic acid is present in the free acid form. In one instance, at least 60% of the polyprotic acid is present in the free acid form. In one instance, at least 70% of the polyprotic acid is present in the free acid form. In one instance, at least 80% of the polyprotic acid is present in the free acid form. In one instance, at least 90% of the polyprotic acid is present in the free acid form. In one instance, at least 99% of the polyprotic acid is present in the free acid form. The compositions described refer to the acid prior to any neutralization that might occur when in contact with the carrier, the animal waste, or otherwise in the environment.

In one instance, the aminopolycarboxylic acid compound comprises 0.1 to 99 weight percent of the composition of the odor inhibitor. In one instance, the aminopolycarboxylic acid compound comprises 10 to 90 weight percent of the composition of the odor inhibitor. In one instance, the aminopolycarboxylic acid compound comprises 25 to 75 weight percent of the composition of the odor inhibitor. In one instance, the aminopolycarboxylic acid compound comprises 40 to 60 weight percent of the composition of the odor inhibitor. In one instance, the polyprotic acid compound comprises 0.1 to 99 weight percent of the composition of the odor inhibitor. In one instance, the polyprotic acid compound comprises 10 to 90 weight percent of the composition of the odor inhibitor. In one instance, the polyprotic acid compound comprises 25 to 75 weight percent of the composition of the odor inhibitor. In one instance, the polyprotic acid compound comprises 40 to 60 weight percent of the composition of the odor inhibitor.

A person of ordinary skill in the art can readily determine the effective amount of odor inhibitor used in combination with the carrier material. This effective amount can be expressed as a weight percentage or as a part per million In either case, the effective amount of the odor inhibitor is calculated based on the total quantity of material in the animal bedding material, including, but not limited to, the odor inhibitor, the carrier material and any additives. The amount required for effective treatment may depend on the bulk density of the carrier material. By way of non-limiting example, suitable amounts may include at least 0.01 weight percent, preferably at least 0.1 weight percent, more preferably at least 0.15 weight percent, based on the total weight of the carrier material. Although there is no particular upper limit on the amount of the odor inhibitor, in some embodiments it may be desirable to use 10 weight percent or less, alternatively 8 weight percent or less, alternatively 5 weight percent or less, alternatively 1.2 weight percent or less, or alternatively 0.5 weight percent or less, based on the total weight of the carrier material. In one instance, the quantity of odor inhibitor is at least 500 ppm. In one instance, the quantity of odor inhibitor is at least 1000 ppm. In one instance, the quantity of odor inhibitor is at least 1500 ppm. In one instance, the quantity of odor inhibitor is at least 2000 ppm. In one instance, the quantity of odor inhibitor is at least 2500 ppm. In one instance, the quantity of odor inhibitor is at least 3000 ppm. In one instance, the quantity of odor inhibitor is at least 4000 ppm. In one instance, the quantity of odor inhibitor is at least 5000 ppm. The upper limit of the odor inhibitor will primarily be governed by cost, for example not more than 100,000 ppm, more preferably not more than 50,000 ppm.

In some embodiments, the liquid binder is a liquid solution which, when combined with the odor inhibitor and the carrier material, forms granules such that during transport and typical use, a majority of the granules will substantially hold their shape. In some instances the liquid binder is water, salt solutions, solutions of EDTA salts, glycols, propylene glycol, glycerin, polyethylene glycol, polypropylene glycol, polyalkylene glycol lubricants, or a combination thereof. Preferably, the liquid binder is a liquid at room temperature. Preferably, the liquid binder has low toxicity.

In another aspect, the invention provides improved efficiency in prevention of urea degradation due to the preferred placement of the odor inhibitor at or near the surface of the litter particles.

The compositions and methods described herein may contain other additives, besides the odor inhibitor and carrier material, that are typically used in animal litters. These include, but are not limited to, fillers, humectants, disintegrants, odor absorbing materials (e.g., sodium carbonate, potassium carbonate, calcium carbonate, siliceous material, opaline silica, activated carbon, sodium bisulfate complex, or corn starch), zeolite, dedusting agents (e.g., gaur gum, PTFE coated clay, or fluoropolymers), antimicrobials such as bronopol and silver based compounds, fragrances, other chelants (diethylenetriaminepentaacetic acid (DTPA) for example), gypsum, diatomite, talc, sand, glass, dirt, alumina, alumina-silicates, silicates, small molecule organic acids, polymers with neutralization capacity or acid groups (e.g., cellulose acetate, polyxcarboxylates), rice flour, quaternary amines, probiotic bacteria and/or ammonia oxidizing bacteria, or a combination thereof. The additive material is preferably added prior to applying the animal waste.

In some embodiments, the carrier material described herein is free of other odor preventing additives, for instance it is free of one or more of: an alkali metal tetraborate n-hydrate, alum, other transition metal salts (e.g., Zn, copper salts) and/or boron compounds.

The addition of the odor inhibitor to the carrier material, as described herein, results in the prevention of ammonia, thereby significantly reducing undesirable animal odors. The odor inhibitor can be incorporated with the carrier material by a variety of standard techniques known to those skilled in the art including, for instance, spraying, solids mixing (including dry blending or co-grinding), spreading, sprinkling, crystallization/precipitation of the odor inhibitor onto the carrier material, and the like.

For instance, in one embodiment, the odor inhibitor may be sprinkled over the top of a bed of the carrier material. In this embodiment the bed of carrier material may be further agitated to mix the odor inhibitor deeper into the material. The sprinkled odor inhibitor may also include a carrier or a flow aid that helps disperse the odor inhibitor throughout the litter bed.

In another embodiment, the odor inhibitor may be dry blended with the carrier material and packaged together prior to use as an animal litter. In a preferred embodiment, the odor inhibitor is made into granules prior to dry blending such that the granules and the carrier material are of a similar size and shape so to inhibit demixing or stratification of the odor inhibitor containing particles from the carrier due to segregation.

In any of the embodiments above, different equipment may be used in order to accomplish the incorporation of the odor inhibitor and the carrier material.

When mixing the odor inhibitor, it may be desirable to match the particle density as well as shape of the carrier material to reduce the likelihood of particle segregation.

Other mixing techniques may include dry briquetting the mixture of carrier material and odor inhibitor to have both incorporated uniformly in the process (e.g., a size range from hundreds of microns to millimeters may be suitable).

In some embodiments, the odor inhibitor may be applied to the carrier material prior to the animal releasing its waste on the carrier material. In some embodiments, the odor inhibitor may be applied or reapplied to the carrier material for second or subsequent generations of use.

In a preferred embodiment, the odor inhibitor is made into a fine powder prior to dry blending to enhance the coatability of the odor inhibitor onto the carrier material. The fine powder may be produced by spray drying, grinding, precipitation or combination thereof, and may be combined with a flow aid by dry blending or binding with a liquid to enhance attachment to the carrier. In another preferred embodiment, a liquid is mixed in with the odor inhibitor powder and the carrier to aid with binding the odor inhibitor onto the carrier. That liquid may, for instance, be water, or a solvent or an oil or a solution of the odor inhibitor, or any liquid whose presence enhances the adhesion of the odor inhibitor powder to the carrier.

In another embodiment, the carrier material may be sprayed with a binder liquid and then blended with dry odor inhibitor so that the dry particles are attached to the carrier material by the binder liquid at a desired concentration. Likewise, the carrier material may be blended with dry odor inhibitor and then sprayed with a binder liquid so that the dry particles are attached to the carrier material by the binder liquid at a desired concentration. The coated carrier particles may then optionally be dried in order to evaporate water or a solvent component that may optionally be present in the binder liquid. Preferably, the binder is at least partially water soluble. Possible binders may comprise solutions of starch, water, polyethylene glycol, polypropylene glycol, or the odor inhibitor itself.

The bacteria described herein are the naturally occurring Staphylococcus-xylosus and Staphylococcus-cohnii bacteria which are commonly present in the natural flora, as well as in animal waste. As used herein, “providing a bacteria” means that a bacteria is introduced to the system. Preferably, the bacteria is introduced to the system as part of the animal waste.

The present disclosure describes a composition and method for suppressing the formation of ammonia comprising providing a carrier material to a container having a headspace; providing a bacteria and an odor inhibitor to the carrier material, the bacteria comprising Staphylococcus-xylosus and/or Staphylococcus-cohnii bacteria, and the odor inhibitor comprising an aminopolycarboxylic acid compound and a polyprotic acid compound; and applying animal waste to the carrier material; wherein there is a 5 to 98 percent improvement of ammonia content in the headspace as compared to an untreated control comprising a container containing the carrier material and the bacteria and not contain the odor inhibitor.

Some embodiments of the invention will now be described in detail in the following Examples.

### EXAMPLES

Synthetic Urine Preparation. In these examples, synthetic urine is prepared as follows. In a sterilized bottle add the following components: Urea (USP Grade): 85.0 g, Sodium Chloride (Morton's® Table Salt or USP Grade): 9.0 g, Magnesium Sulfate Heptahydrate (ACS Grade): 0.4 g, Calcium Acetate Hydrate (99% purity): 0.7 g Potassium Sulfate (ACS Certified): 4.0 g, and Ammonium Sulfate (ACS Certified): 2.4 g. 1000 g of reverse osmosis purified water is added to a separate sterilized bottle. The purified water is poured into the bottle containing the components. The bottle is capped and placed on a bottle roller at ambient temperature for 1 to 3 hours. The pH of the solution is measured to confirm the pH is between 6.5 and 7. If the pH is greater than 7 then ammonium sulfate is added to bring the pH into range (generally 0.2 to 0.3 g).

Bacteria Preparation. In these examples, the bacteria used is listed in Table 1 where “E1” and “E2” refer to environmental isolates from cat feces and “ATCC” followed by a number refers to the ATCC catalog number of a bacterial strain. Each bacteria strain is isolated on a sterile tryptic soy agar plate and stored in the refrigerator. A fresh plate is prepared every 2 weeks. The strain marked E1 is sent to an external lab for DNA sequencing and did not provide a conclusive result regarding strain. The strain marked E2 was sent to an external lab for DNA sequencing and was matched to Staphylococcus-cohnii and Staphylococcus-xylosus with genus confidence level.

Each bacteria is grown the day before the start of the experiments by taking a loopful of the bacteria from the agar plate with a 10 uL loop and immersing it in 10 mL sterile tryptic soy broth filling half of the container. All bacteria used in the examples are aerobic and therefore need air on top of the growth medium. The vial is incubated at 30 degrees C. in a shaking incubator at 100 rpm for 24 hours. The count of the bacteria in the growth media can be determined by the serial dilutions method, where 10 serial dilutions of the growth medium in sterile Physiological Buffered Saline (PBS) solution are performed with 10× dilution each time. Each dilution is plated twice using 100 μL of growth media for each plate. The numbers of colonies are counted on the dilution plate that has between 30 and 300 colony forming units (CFU) on it. The number of colony forming units in the original growth media is then determined by back-calculating the number of dilutions.

All pipettes, containers, tips, spoons etc. equipment used for these experiments are sterile in order to prevent contamination with other bacteria. Litters and standalone treatments are used as-is, without sterilization.

Litter Preparation (liquid spray method). National 12 Bentonite (particle size approximately 1.6 mm) cat litter is loaded into a drum coater, and the drum is spun at a rotation rate of 10-20 rpm. The drum coater is 2 feet in diameter and 6 inches deep, with twelve 1 inch tall triangular louvers completely seal-welded to the drum. K₂EDTA is sprayed onto the litter using a 38.6 wt % solution of K₂EDTA sprayed onto the rolling bed of litter in the drum coater using a recycled glass cleaner spray bottle. The weight of the spray bottle is recorded prior to spraying. A target weight is calculated from the amount of liquid expected to be sprayed onto the litter (based on additive loading and the mass of litter in the coater). As the solution is sprayed onto the litter, the weight of the spray bottle is checked periodically so that the amount of additive sprayed is as close to the target as possible. After spraying, the spray bottle is again weighed and the actual amount of liquid added to the litter is noted. As used here, the odor inhibitor content in the prepared litter is reported as parts per million (ppm) and is reported in Table 1 as Odor Inhibitor Concentration (Conc.). Typical application levels of EDTA salt utilized for testing are between 5,000 and 15,000 ppm EDTA salt.

Litter Preparation (sprinkled method). National 12 Bentonite (particle size approximately 1.6 mm) cat litter is loaded into the container as described below in Sample Preparation and crystals of the odor inhibitor identified in Table 1 are sprinkled over the top surface of the cat litter to achieve the testing concentration of the odor inhibitor. Where two odor inhibitors are used in a particular preparation, Table 1 lists the odor inhibitors used and their ratio (by weight). As used here, the odor inhibitor content in the prepared litter is reported as parts per million (ppm) and is reported in Table 1 as Odor Inhibitor Concentration (Conc.), where more than one odor inhibitor is used the combined concentration is reported.

Sample Preparation. Charge a sterilized 1 L (ex. Tri-Pour®) container with 190 g of untreated or spray treated litter. Weigh and set aside 10 g of litter the same litter for each test sample. Level the litter in each test sample by tapping on the container. Create a depression approximately 17 mm in depth and 27.5 mm in diameter in the center of the litter sample, using a clean 50 mL conical tube. Use a fresh sterile tube for each type of sample. If the “sprinkled treatment” method will be used, sprinkle the required amount of treatment on the litter at this point. Please note that the treatment type is given in Table 1 for each respective example. Prepare the inoculation solution by diluting the bacteria solution in tryptic soy broth with sterile PBS to yield the bacteria concentration listed in Table 1 (CFU/ml). Immediately before inoculation of each sample, add 3 mL of the inoculation solution into 37 mL of synthetic urine in a sterile 50 mL centrifuge container, vortex mix it for 3 seconds and pour it in the depression on the litter. Evenly sprinkle the remaining 10 g of litter set aside on the top of the mixture. An aluminum foil sheet is used to cover the beaker to prevent vapors from escaping the beaker.

Note that the concentration of the bacteria in the sample can be varied by the dilution step with sterile PBS. For all experiments, 3 mL bacteria mixture with PBS and 37 mL synthetic urine were used to keep the amount of urea constant for each sample.

Headspace Ammonia Measurement. The ammonia in the headspace of each test container is sampled using a SENSIDYNE® AP-20S Aspirating Detector Tube Pump. Low (0.2-20 ppm) or high (5-260 ppm) range SENSIDYNE® Ammonia Gas Detector Tubes are used to quantify the headspace ammonia concentration. The following procedure is used for ammonia detection and quantification in each test sample. 1. Break both ends of the detector tube using the breaking port on pump. 2. Point the arrow mark on the detector tube towards the aspirating pump. Insert the detector tube securely into the rubber tube connector of the aspirating pump. 3. To sample the test headspace, pierce a small hole in the center of the aluminum foil cover of the test sample. Insert the detector tube (attached to the aspirating pump) into the sampling hole to the specified measurement distance. Insert the tube into the headspace to 45 mm, equal to the thick blue line on the bottom end of the gas detector tube). 4. Hold the pump at the 45 mm measurement distance. Pull the pump handle at full stroke to the locked position. Wait for 1 minute until sampling is complete which is confirmed with the flow indicator of the pump. The instruction manual of the aspirating pump will give more details if necessary. 5. Read the scale at the maximum point of the stained layer (yellow in color). Read and report the concentration immediately after measurement. If the reading is off scale, for example 20 ppm for the low range tubes, repeat the measurement using the high range gas detector tube. 6. After sampling, seal the sampling hole in the aluminum foil cover with tape 7. Ammonia samples are collected after 10 days with results reported in Table 1. Each row of the table represents a test run with the listed bacteria strain and concentration of the bacteria. The ammonia content in the headspace is reported as a percent improvement. The percent improvement is calculated as the percent decrease of ammonia in the headspace as compared to a control containing the same bacteria strain and concentration tested using the procedure above except omitting the odor inhibitor (the salt of an aminopolycarboxylic acid compound).

The results are summarized in Table 1.

TABLE 1

| | | | Odor | | | Headspace |
|---|---|---|---|---|---|---|
| | Bacteria | Litter | Inhibitor | Odor Inhibitor; | % improvement | ammonia for |
| | Concentration | Preparation | Conc. | Odor Inhibitor | in headspace | untreated control |
| Bacteria | (CFU/mL) | Method | (ppm) | Ratio | ammonia (day 10) | sample (ppm) |
| EI1 - undetermined | 6.1E+07 | Spray | 15000 | K₂EDTA | 76 | 8 |
| EI1 - undetermined | 9.25E+07 | Spray | 15000 | K₂EDTA | 87.5 | 24 |
| EI2 - Staphylococcus-cohnii/Staphylococcus-xylosus | 4.1E+07 | Spray | 15000 | K₂EDTA | 73.3 | 22.2 |
| EI2 - Staphylococcus-cohnii/Staphylococcus xylosus | 6.0E+07 | Spray | 15000 | K₂EDTA | 75 | 22.8 |
| ATCC 29971 - Staphylococcus xylosus type strain | 3.65E+08 | Spray | 15000 | K₂EDTA | 67.7 | 33 |
| ATCC 12162 - Staphylococcus xylosus strain | 3.62E+08 | Spray | 15000 | K₂EDTA | 66.7 | 38 |
| ATCC 35033 - Staphylococcus xylosus strain | 2.5E+08 | Spray | 15000 | K₂EDTA | 36 | 12.5 |
| ATCC 35663 - Staphylococcus xylosus strain | 5.85E+07 | Spray | 15000 | K₂EDTA | 50 | 16 |
| ATCC29905 - Proteus vulgaris | 6.0E+08 | Spray | 15000 | K₂EDTA | 0 | 130 |
| ATCC29905 - Proteus vulgaris | 1.51E+08 | Spray | 15000 | K₂EDTA | 0 | 7.6 |
| ATCC29906 - Proteus mirabilis | >3.0E+09 | Spray | 15000 | K₂EDTA | 83 | 12.1 |
| ATCC29906 - Proteus mirabilis | >3.0E+09 | Spray | 15000 | K₂EDTA | 50 | 3.7 |
| EI2: Staphylococcus-cohnii/Staphylococcus-xylosus | 5.0E+07 | Spray | 5000 | K₂EDTA | 75 | 21 |
| EI2: Staphylococcus-cohnii/Staphylococcus-xylosus | 5.0E+07 | Spray | 15000 | K₂EDTA | 75 | 22.2 |
| EI2: Staphylococcus-cohnii/Staphylococcus-xylosus | 5.0E+07 | Spray | 15000 | K₂EDTA | 75 | 21 |
| EI2: Staphylococcus-cohnii/Staphylococcus-xylosus | 5.0E+07 | Sprinkle | 5000 | Na₂EDTA | 55 | 35 |
| EI2: Staphylococcus-cohnii/Staphylococcus-xylosus | 5.0E+07 | Sprinkle | 5000 | Na₂EDTA | 80 | 34.5 |
| EI2: Staphylococcus-cohnii/Staphylococcus-xylosus | 5.0E+07 | Sprinkle | 15000 | Na₂EDTA | 88 | 35 |
| EI2: Staphylococcus-cohnii/Staphylococcus-xylosus | 5.0E+07 | Sprinkle | 15000 | Na₂EDTA | 97 | 34.5 |
| EI2: Staphylococcus-cohnii/Staphylococcus-xylosus | 5.0E+07 | Sprinkle | 5000 | Na₂EDTA, | 95 | 18 |
| | | | | citric acid; 1:3 | | |
| EI2: Staphylococcus-cohnii/Staphylococcus-xylosus | 5.0E+07 | Sprinkle | 15000 | Na₂EDTA, | 100 | 18 |
| | | | | citric acid; 1:3 | | |
| EI2: Staphylococcus-cohnii/Staphylococcus-xylosus | 5.0E+07 | Sprinkle | 5000 | Na₂EDTA, | 82 | 18 |
| | | | | citric acid; 3:1 | | |
| EI2: Staphylococcus-cohnii/Staphylococcus-xylosus | 5.0E+07 | Sprinkle | 5000 | Na₂EDTA | 69 | 18 |
| EI2: Staphylococcus-cohnii/Staphylococcus-xylosus | 5.0E+07 | Sprinkle | 5000 | citric acid | 82 | 18 |

1. A method for suppressing the formation of ammonia comprising:
providing a carrier material to a container having a headspace;
providing a bacteria and an odor inhibitor to the carrier material, and the odor inhibitor comprising an aminopolycarboxylic acid compound and a polyprotic acid compound, wherein at least one of the aminopolycarboxylic acid compound or the polyprotic acid compound is the salt form of the acid; and
applying animal waste to the carrier material; wherein there is a 5 to 98 percent improvement of ammonia content in the headspace as compared to an untreated control comprising a container containing the carrier material and the bacteria and not contain the odor inhibitor.

2. The method of claim 1, the method further comprising: providing an additive material to the carrier material, wherein the additive material comprises diatomite, talc, gypsum, calcium carbonate, sand, glass, dirt, alumina, alumina-silicates, silicates, microbial control agents, colorants, fragrances, dust control additives, or a combination thereof.

3. The method of claim 1, wherein the aminopolycarboxylic acid compound has an ethylenediamine or diethylenetriamine backbone.

4. The method claim 1, wherein the aminopolycarboxylic acid compound is ethylenediaminetetraacetic acid or the salt thereof, diethylenetriaminepentaacetic acid or the salt thereof, N-hydroxyethylethylenediaminetriacetic acid or the salt thereof, or a mixture of two or more thereof.

5. The method of claim 1, wherein the odor inhibitor comprises 500 to 15000 parts per million (ppm) of the contents of the container.

6. The method of claim 1 wherein the carrier is wood chips, wood shavings, straw, diatomaceous earth, zeolites, bentonite clay, paper byproducts, pine pellets, ground corn cob or pelletized saw dust.

7. The method of claim 1, wherein the polyprotic acid compound comprises citric acid, citrate, maleic, succinic, malonic, aspartic, the salt form of any of these acids, or a combination thereof.

8. An odor control system comprising: a carrier material and an odor inhibitor, the odor inhibitor comprising an aminopolycarboxylic acid compound and a polyprotic acid compound, wherein at least one of the aminopolycarboxylic acid compound or the polyprotic acid compound is the salt form of the acid.

9. The system of claim 8, wherein the aminopolycarboxylic acid compound has an ethylenediamine or diethylenetriamine backbone.

10. The system claim 8, wherein the aminopolycarboxylic acid compound is ethylenediaminetetraacetic acid or the salt thereof, diethylenetriaminepentaacetic acid or the salt thereof, N-hydroxyethylethylenediaminetriacetic acid or the salt thereof, or a mixture of two or more thereof.

11. The system of claim 8, wherein the odor inhibitor comprises 500 to 15000 parts per million (ppm) of the odor control system.

12. The system of claim 8, wherein the polyprotic acid compound comprises citric acid, citrate, maleic, succinic, malonic, aspartic, the salt form of any of these acids, or a combination thereof.
